(19) United States
(12) Patent Application Publication
(10) Pub. No.: US 2026/0307334 A1
(43) Pub. Date: Oct. 8, 2026

(54) THREE-DIMENSIONAL SHAPING APPARATUS

(71) Applicant: SEIKO EPSON CORPORATION, Tokyo (JP)

(72) Inventor: Eiji OKAMOTO, MATSUMOTO-SHI (JP)

(21) Appl. No.: 19/563,456

(22) Filed: Mar. 11, 2026

(30) Foreign Application Priority Data
Mar. 14, 2025 (JP) 2025-041762

(51) Int. Cl. B29C 64/336; B29C 64/295; B33Y 30/00; B33Y 40/00

(52) U.S. Cl. CPC B29C 64/336; B29C 64/295; B33Y 30/00; B33Y 40/00

(57) ABSTRACT

A three-dimensional shaping apparatus is configured including: a plasticizing unit configured to plasticize at least a part of a shaping material containing a thermoplastic resin to generate a plasticized material; a fiber material supply unit configured to supply a fiber material; a nozzle configured to discharge the plasticized material; and an ultrasonic wave applying unit including a storage portion for storing the discharged plasticized material and the supplied fiber material, and configured to apply ultrasonic waves to at least one of the stored plasticized material and fiber material and discharge the plasticized material and the fiber material toward a stage.

The present application is based on, and claims priority from JP Application Serial Number 2025-041762, filed Mar. 14, 2025, the disclosure of which is hereby incorporated by reference herein in its entirety.

### BACKGROUND

### 1. Technical Field

The present disclosure relates to a three-dimensional shaping apparatus.

### 2. Related Art

There is known a three-dimensional shaping apparatus that shapes a three-dimensional shaped object by discharging a plasticized material from a nozzle toward a stage and curing the plasticized material.

For example, JP-A-2019-116104 discloses a three-dimensional printer that melts a fiber-reinforced composite material filament containing a matrix resin with a heater to manufacture a three-dimensional printed component.

JP-A-2019-116104 is an example of the related art.

In the three-dimensional printer as described above, it is desired to improve the strength of the shaped object.

### SUMMARY

A three-dimensional shaping apparatus according to an aspect of the present disclosure is configured including:
a plasticizing unit configured to plasticize at least a part of a shaping material containing a thermoplastic resin to generate a plasticized material;
a fiber material supply unit configured to supply a fiber material;
a nozzle configured to discharge the plasticized material; and
an ultrasonic wave applying unit including a storage portion for storing the discharged plasticized material and the supplied fiber material, and configured to apply ultrasonic waves to at least one of the stored plasticized material and fiber material and discharge the plasticized material and the fiber material toward a stage.

### BRIEF DESCRIPTION OF THE DRAWINGS

FIG. 1 is a diagram illustrating a three-dimensional shaping apparatus according to an embodiment.

FIG. 2 is a cross-sectional view schematically illustrating a discharging unit of the three-dimensional shaping apparatus according to the embodiment.

FIG. 3 is a perspective view schematically illustrating a flat screw of the three-dimensional shaping apparatus according to the embodiment.

FIG. 4 is a plan view schematically illustrating a barrel of the three-dimensional shaping apparatus according to the embodiment.

FIG. 5 is a perspective view schematically illustrating the three-dimensional shaping apparatus according to the embodiment.

FIG. 6 is a plan view schematically illustrating the three-dimensional shaping apparatus according to the embodiment.

FIG. 7 is a graph illustrating a relationship between a temperature and a complex viscosity.

FIG. 8 is a flowchart illustrating processing of a control unit of the three-dimensional shaping apparatus according to the embodiment.

FIG. 9 is a cross-sectional view illustrating shaping layer forming processing of the three-dimensional shaping apparatus according to the embodiment.

FIG. 10 is a cross-sectional view schematically illustrating a three-dimensional shaping apparatus according to a modification of the embodiment.

FIG. 11 is a cross-sectional view schematically illustrating a shaped object shaped in an experimental example.

FIG. 12 is an X-ray CT image of a shaped object of Example 1.

FIG. 13 is an X-ray CT image of a shaped object of Comparative Example 1.

### DESCRIPTION OF EMBODIMENTS

A preferable embodiment of the present disclosure will be described below in detail with reference to the drawings. The embodiment to be described below does not unduly limit the content of the present disclosure described in the claims. Further, not all of the configurations described below are necessarily essential elements of the present disclosure.

### 1. Three-Dimensional Shaping Apparatus

### 1.1. Overall Configuration

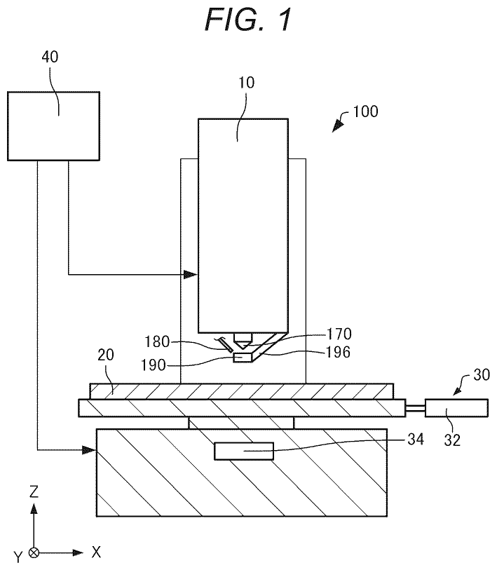

First, a three-dimensional shaping apparatus according to the embodiment will be described with reference to the drawings. FIG. 1 is a diagram illustrating a three-dimensional shaping apparatus 100 according to the embodiment. FIG. 1 illustrates an X axis, a Y axis, and a Z axis as three axes orthogonal to one another. An X-axis direction and a Y-axis direction are, for example, horizontal directions. A Z-axis direction is, for example, a vertical direction.

As illustrated in FIG. 1, the three-dimensional shaping apparatus 100 includes, for example, a discharging unit 10, a stage 20, a position changing unit 30, and a control unit 40. For convenience, in FIG. 1, the discharging unit 10 is illustrated in a simplified manner.

While causing the discharging unit 10 to discharge a plasticized shaping material toward the stage 20, the three-dimensional shaping apparatus 100 drives the position changing unit 30 to change relative positions of the discharging unit 10 and the stage 20. Accordingly, the three-dimensional shaping apparatus 100 shapes a shaped object having a desired shape by laminating shaping layers on the stage 20. The three-dimensional shaping apparatus 100 is a three-dimensional shaping apparatus of a fused deposition modeling (FDM) type.

The discharging unit 10 discharges a plasticized material and a fiber material toward the stage 20. The discharging unit 10 is movable relative to the stage 20. The discharging unit 10 will be described in detail later.

The stage 20 is provided below the discharging unit 10. In the illustrated example, the stage 20 is a rectangular parallelepiped. The shaping material and the fiber material discharged from the discharging unit 10 are deposited on the stage 20. The material of the stage 20 is, for example, metal such as aluminum.

The position changing unit 30 supports the stage 20. The position changing unit 30 changes relative positions of the discharging unit 10 and the stage 20. In the illustrated example, the position changing unit 30 moves the stage 20 in the X-axis direction and the Y-axis direction, thereby changing the relative positions of the discharging unit 10 and the stage 20 in the X-axis direction and the Y-axis direction. Further, the position changing unit 30 moves the discharging unit 10 in the Z-axis direction, thereby changing the relative positions of the discharging unit 10 and the stage 20 in the Z-axis direction.

The position changing unit 30 includes, for example, a first electric actuator 32, a second electric actuator 34, and a third electric actuator 36. The first electric actuator 32 moves the stage 20 in the X-axis direction. The second electric actuator 34 moves the stage 20 in the Y-axis direction. The third electric actuator 36 moves the discharging unit 10 in the Z-axis direction. The electric actuators 32, 34, and 36 are controlled by the control unit 40.

A configuration of the position changing unit 30 is not particularly limited as long as the position changing unit 30 can change the relative positions of the discharging unit 10 and the stage 20. For example, the position changing unit 30 may move the stage 20 in the Z-axis direction and move the discharging unit 10 in the X-axis direction and the Y-axis direction. The position changing unit 30 may move the stage 20 or the discharging unit 10 in the X-axis direction, the Y-axis direction, and the Z-axis direction.

The control unit 40 includes, for example, a computer including a processor, a main storage device, and an input and output interface for receiving and outputting signals from and to the outside. The processor executes programs read in the main storage device, whereby the control unit 40 exerts various functions. Specifically, the control unit 40 controls the discharging unit 10 and the position changing unit 30. The control unit 40 may include a combination of a plurality of circuits rather than the computer.

### 1.2. Discharging Unit

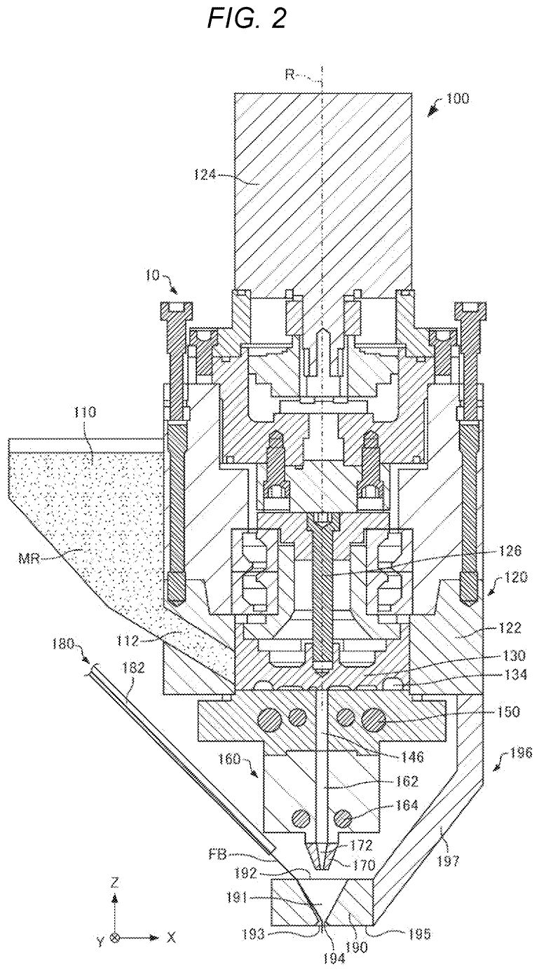

FIG. 2 is a cross-sectional view schematically illustrating the discharging unit 10 of the three-dimensional shaping apparatus 100. As illustrated in FIG. 2, the discharging unit 10 includes, for example, a shaping material supply unit 110, a plasticizing unit 120, a block body 160, a nozzle 170, a fiber material supply unit 180, an ultrasonic wave applying unit 190, and a support portion 196.

The shaping material supply unit 110 stores a shaping material MR. The shaping material supply unit 110 supplies the shaping material MR to the plasticizing unit 120. The shaping material supply unit 110 includes, for example, a hopper. The shaping material MR has, for example, a pellet form or a powder form.

The shaping material MR supplied from the shaping material supply unit 110 contains a thermoplastic resin. Examples of the thermoplastic resin include general-purpose plastic, general-purpose engineering plastic, and super engineering plastic. Examples of the general-purpose plastic include polypropylene (PP), polyethylene (PE), polyvinyl chloride (PVC), and polylactic acid (PLA). Examples of the general-purpose engineering plastic include polyacetal (POM), polyamide (PA), polycarbonate (PC), modified polyphenylene ether (m-PPE), polybutylene terephthalate (PBT), and polyethylene terephthalate (PET). Examples of the super engineering plastic include polysulfone (PSU), polyethersulfone (PES), polyphenylene sulfide (PPS), polyarylate (PAR), polyimide (PI), polyamideimide (PAI), polyetherimide (PEI), and polyetheretherketone (PEEK).

The shaping material MR supplied from the shaping material supply unit 110 may include short fibers such as chopped carbon fibers. The fiber length of the short fibers is, for example, 10 μm or more and 500 μm or less, and is preferably 50 μm or more and 200 μm or less. The short fibers contained in the shaping material MR are not limited to carbon fibers, and may be glass fibers or fibers (Kevlar (registered trademark)) obtained by polymerization of p-phenylenediamine and terephthalic acid chloride. Since the shaping material MR contains the short fibers, the short fibers can be entangled with each other at boundaries of adjacent shaping layers among a plurality of shaping layers deposited on the stage 20, and strength at the boundaries of the adjacent shaping layers can be improved.

The shaping material MR supplied from the shaping material supply unit 110 may include a metal material and a ceramic material. Examples of the metal material include single metal such as magnesium (Mg), iron (Fe), cobalt (Co), chromium (Cr), aluminum (Al), titanium (Ti), copper (Cu), and nickel (Ni), an alloy containing one or more of these types of metal, maraging steel, stainless steel, cobalt chromium molybdenum, a titanium alloy, a nickel alloy, an aluminum alloy, a cobalt alloy, and a cobalt chromium alloy. Examples of the ceramic material include oxide ceramic such as silicon dioxide, titanium dioxide, aluminum oxide, and zirconium oxide, and non-oxide ceramic such as aluminum nitride.

The shaping material supply unit 110 and the plasticizing unit 120 are coupled by a supply path 112. The shaping material MR supplied to the shaping material supply unit 110 is supplied to the plasticizing unit 120 via the supply path 112.

The plasticizing unit 120 includes, for example, a screw case 122, a drive motor 124, a shaft 126, a flat screw 130, a barrel 140, and a heater 150.

The plasticizing unit 120 plasticizes at least a part of the shaping material MR in a solid state supplied from the shaping material supply unit 110, generates a plasticized material in a paste form having fluidity, and supplies the plasticized material to the block body 160. For convenience, the plasticized material is not illustrated in FIG. 2.

Plasticizing is a concept including melting and means changing a solid state to a fluid state. Specifically, in the case of a material in which glass transition occurs, plasticizing means setting the temperature of the material to temperature equal to or higher than the glass transition point. In the case of a material in which glass transition does not occur, plasticizing means setting the temperature of the material to a temperature equal to or higher than a melting point thereof.

The screw case 122 is a housing that accommodates the flat screw 130. In the illustrated example, the barrel 140 is provided below the screw case 122. The flat screw 130 is accommodated in a space surrounded by the screw case 122 and the barrel 140.

The drive motor 124 is provided, for example, above the flat screw 130. The drive motor 124 is, for example, a servo motor. The drive motor 124 is controlled by the control unit 40.

The shaft 126 is coupled to the drive motor 124 via, for example, a speed reducer. The shaft 126 is rotated by the drive motor 124. In the illustrated example, the shaft 126 extends in the Z-axis direction. The shaft 126 rotates about an axis parallel to the Z axis as a rotation axis R. The shaft 126 is coupled to the flat screw 130. The shaft 126 transmits a torque generated by the drive motor 124 to the flat screw 130.

The flat screw 130 is provided between the barrel 140 and the drive motor 124. The flat screw 130 has a substantially cylindrical shape, a dimension of which in a rotation axis R direction is smaller than a dimension in a direction orthogonal to the rotation axis R direction. The flat screw 130 is rotated about the rotation axis R by the torque generated by the drive motor 124.

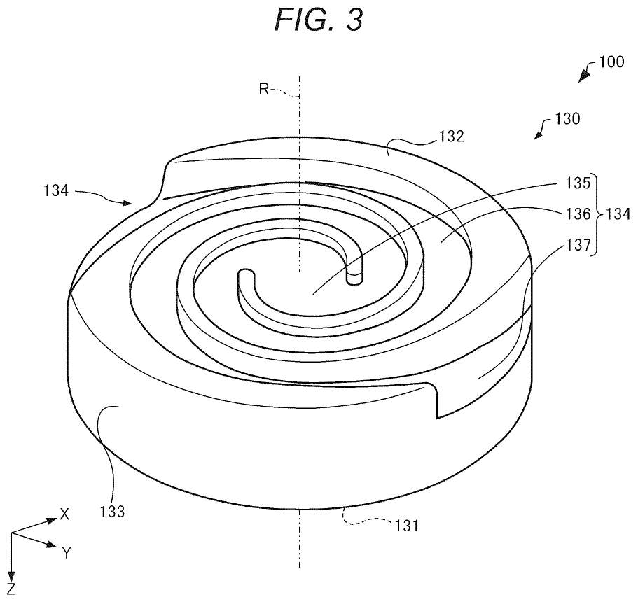

The flat screw 130 has, for example, a shaft surface 131 to which the shaft 126 is coupled, a groove forming surface 132 on an opposite side from the shaft surface 131, and a coupling surface 133 coupling the shaft surface 131 and the groove forming surface 132. A first groove 134 is formed in the groove forming surface 132. The coupling surface 133 is, for example, perpendicular to the groove forming surface 132. Here, FIG. 3 is a perspective view schematically illustrating the flat screw 130.

As illustrated in FIG. 3, the first groove 134 is formed in the groove forming surface 132 of the flat screw 130. The first groove 134 includes, for example, a central portion 135, a coupling portion 136, and a material introduction portion 137. The central portion 135 faces a communication hole 146 formed in the barrel 140. The central portion 135 communicates with the communication hole 146. The coupling portion 136 couples the central portion 135 and the material introduction portion 137. In the illustrated example, the coupling portion 136 is provided in a spiral shape from the central portion 135 toward an outer circumference of the groove forming surface 132. The material introduction portion 137 is provided at the outer circumference of the groove forming surface 132. That is, the material introduction portion 137 is provided at the coupling surface 133 of the flat screw 130. The material supplied from the shaping material supply unit 110 is introduced from the material introduction portion 137 into the first groove 134, passes through the coupling portion 136 and the central portion 135, and is conveyed to the communication hole 146 formed in the barrel 140. For example, two first grooves 134 are formed.

The number of first grooves 134 is not particularly limited. Although not illustrated, three or more first grooves 134 may be formed or only one first groove 134 may be formed. Although not illustrated, the plasticizing unit 120 may include, rather than the flat screw 130, an elongated in-line screw including a spiral groove in a side surface thereof. The plasticizing unit 120 may plasticize the shaping material according to rotation of the in-line screw.

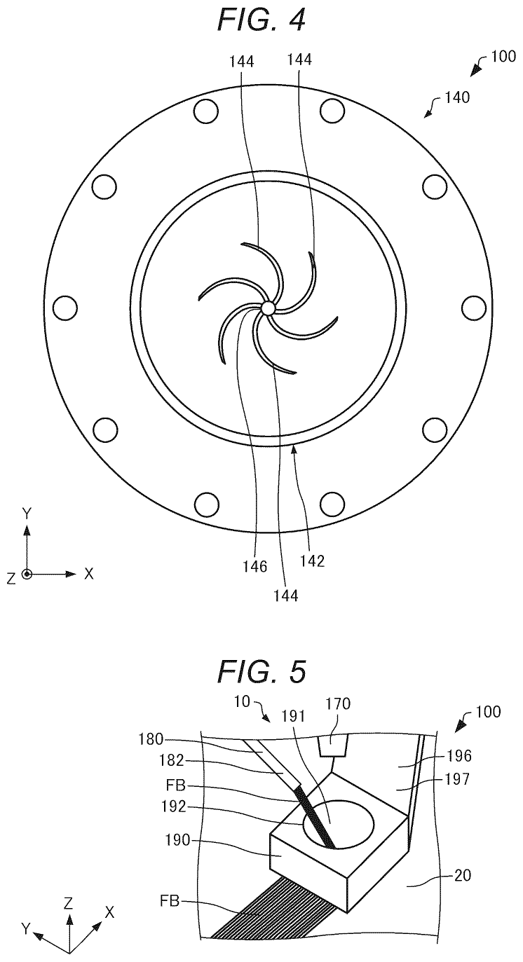

As illustrated in FIG. 2, the barrel 140 is provided below the flat screw 130. The barrel 140 is provided between the flat screw 130 and the block body 160. The barrel 140 has a facing surface 142 facing the groove forming surface 132 of the flat screw 130. The communication hole 146 communicating with the first groove 134 is formed at the center of the facing surface 142. Here, FIG. 4 is a plan view schematically illustrating the barrel 140.

As illustrated in FIG. 4, a second groove 144 and the communication hole 146 are formed in the facing surface 142 of the barrel 140. A plurality of second grooves 144 are formed. In the illustrated example, six second grooves 144 are formed. However, the number of second grooves 144 is not particularly limited. The plurality of second grooves 144 are formed around the communication hole 146 as viewed from the Z-axis direction. One end of the second groove 144 is coupled to the communication hole 146 and extends spirally from the communication hole 146 toward the outer circumference of the barrel 140. The second groove 144 guides the plasticized material to the communication hole 146. The communication hole 146 extends, for example, in the X-axis direction.

Although not illustrated, the shape of the second groove 144 is not particularly limited and may be, for example, a linear shape. One end of the second groove 144 may not be coupled to the communication hole 146. Further, the second groove 144 may not be formed in the facing surface 142. However, in consideration of efficiently guiding the plasticized material to the communication hole 146, the second groove 144 is preferably formed in the facing surface 142.

As illustrated in FIG. 2, the heater 150 is provided in the barrel 140. The heater 150 heats the shaping material MR supplied between the flat screw 130 and the barrel 140. An output of the heater 150 is controlled by the control unit 40. The plasticizing unit 120 heats the shaping material MR while conveying the shaping material MR toward the communication hole 146 by the flat screw 130, the barrel 140, and the heater 150 to generate the plasticized material. Then, the plasticizing unit 120 causes the generated plasticized material to flow out from the communication hole 146.

Although not illustrated, the heater 150 may have a ring shape as viewed from the Z-axis direction. The heater 150 may not be provided in the barrel 140, and may be provided in the vicinity of the barrel 140 at the block body 160.

The block body 160 is provided below the barrel 140. The block body 160 is provided between the barrel 140 and the nozzle 170. The material of the block body 160 is, for example, a metal such as steel use stainless (SUS).

A block flow channel 162 is formed in the block body 160. In the illustrated example, the block flow channel 162 extends in the Z-axis direction. The block flow channel 162 communicates with the communication hole 146 formed in the barrel 140. The plasticized material is supplied from the communication hole 146 to the block flow channel 162.

The block body 160 includes a nozzle heater 164. The nozzle heater 164 is provided in the vicinity of the nozzle 170. The nozzle heater 164 heats the plasticized material flowing through the block flow channel 162 and the nozzle 170. An output of the nozzle heater 164 is controlled by the control unit 40. A temperature of the nozzle heater 164 may be the same as a temperature of the heater 150 provided in the barrel 140. The nozzle heater 164 may have a ring shape surrounding the block flow channel 162 as viewed from the Z-axis direction.

The nozzle 170 is provided below the block body 160. The nozzle 170 is provided between the block body 160 and the ultrasonic wave applying unit 190. A nozzle flow channel 172 is formed in the nozzle 170. In the illustrated example, the nozzle flow channel 172 extends in the Z-axis direction. The nozzle flow channel 172 communicates with the block flow channel 162. The plasticized material is supplied from the block flow channel 162 to the nozzle flow channel 172. The nozzle 170 discharges the plasticized material supplied to the nozzle flow channel 172 toward the stage 20 via the ultrasonic wave applying unit 190.

The fiber material supply unit 180 supplies a fiber material FB to the ultrasonic wave applying unit 190. The fiber material supply unit 180 includes, for example, a drive unit (not illustrated) and a supply pipe 182. The fiber material FB is moved in the supply pipe 182 by driving of the drive unit and is supplied to the ultrasonic wave applying unit 190. The drive unit includes, for example, a plunger and a cylinder. The drive unit may include a pair of rollers. The driving of the drive unit is controlled by the control unit 40. The material of the supply pipe 182 is, for example, polytetrafluoroethylene (PTFE) or silicone resin.

Examples of the fiber material FB supplied from the fiber material supply unit 180 include carbon fibers, glass fibers, and Kevlar (registered trademark). The fiber material FB supplied from the fiber material supply unit 180 is, for example, a fiber bundle in which a plurality of fibers are bundled up. The fiber material supply unit 180 supplies, for example, the fiber material FB that is a fiber bundle in which several thousands of fibers are bundled up. A diameter of the fiber material FB as the fiber bundle supplied from the fiber material supply unit 180 may be 0.1 mm or more, 0.3 mm or more, about 0.4 mm, or 1 mm or less. The number of fibers constituting the fiber bundle is not particularly limited. The fiber material supply unit 180 may supply one fiber as the fiber material FB.

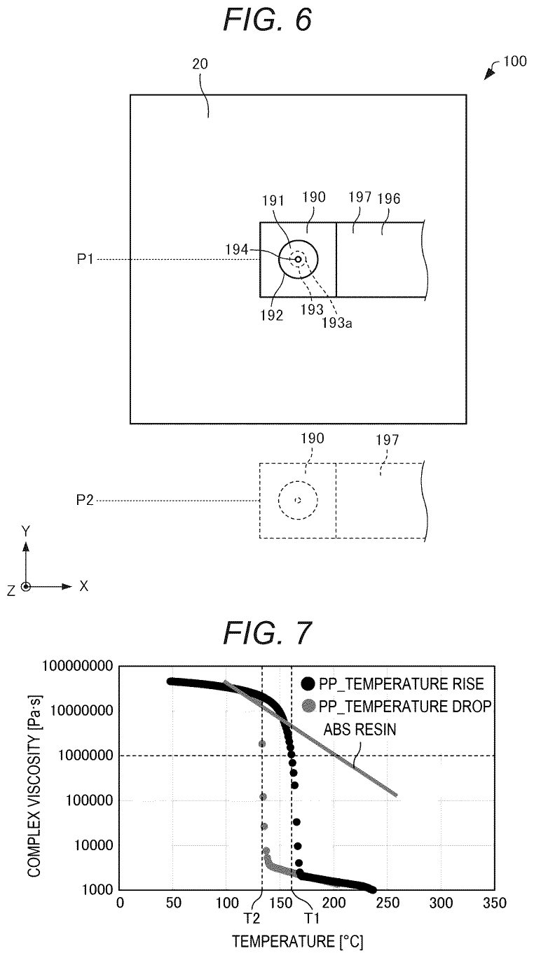

The ultrasonic wave applying unit 190 is provided below the nozzle 170. The ultrasonic wave applying unit 190 is separated from the nozzle 170 and the fiber material supply unit 180. Here, FIG. 5 is a perspective view schematically illustrating the three-dimensional shaping apparatus 100. FIG. 6 is a plan view schematically illustrating the three-dimensional shaping apparatus 100. For convenience, in FIG. 5, members other than the stage 20, the nozzle 170, the fiber material supply unit 180, the ultrasonic wave applying unit 190, and the support portion 196 are not illustrated. In FIG. 6, members other than the stage 20, the ultrasonic wave applying unit 190, and the support portion 196 are omitted.

As illustrated in FIGS. 5 and 6, the ultrasonic wave applying unit 190 includes a storage portion 191. The storage portion 191 runs through the ultrasonic wave applying unit 190 in the Z-axis direction. The storage portion 191 stores the plasticized material discharged from the nozzle 170 and the fiber material FB supplied from the fiber material supply unit 180. The storage portion 191 stores the plasticized material and the fiber material FB before the plasticized material and the fiber material FB reach the stage 20.

As illustrated in FIG. 2, the storage portion 191 of the ultrasonic wave applying unit 190 has, for example, a first opening 192, a second opening 193, and a narrow portion 194. The plasticized material discharged from the nozzle 170 and the fiber material FB from the fiber material supply unit 180 are supplied to the first opening 192. The plasticized material and the fiber material FB supplied from the first opening 192 are discharged from the second opening 193 toward the stage 20. An area of the first opening 192 is larger than an area of the second opening 193. As illustrated in FIG. 6, an edge 193a of the second opening 193 is curved. The first opening 192 and the second opening 193 has, for example, a circular shape. A position of a center of the first opening 192 and a position of a center of the second opening 193 coincide with each other, for example. As illustrated in FIG. 2, the narrow portion 194 is located between the first opening 192 and the second opening 193. The area of the narrow portion 194 is smaller than the area of the second opening 193.

The storage portion 191 of the ultrasonic wave applying unit 190 has a reverse tapered shape in which a width gradually decreases from the first opening 192 to the narrow portion 194 in a −Z-axis direction. Further, the storage portion 191 has a tapered shape in which the width gradually increases from the narrow portion 194 to the second opening 193 in the −Z-axis direction.

The ultrasonic wave applying unit 190 generates ultrasonic waves by vibrating. A frequency of the ultrasonic waves generated by the ultrasonic wave applying unit 190 is, for example, 20 kHz or more and 60 kHz or less. Driving of the ultrasonic wave applying unit 190 is controlled by the control unit 40.

The ultrasonic wave applying unit 190 comes into contact with the plasticized material and the fiber material FB at an inner wall of the storage portion 191, for example. Accordingly, the ultrasonic wave applying unit 190 applies ultrasonic waves to the plasticized material and the fiber material FB. In the storage portion 191, for example, the fiber material FB is impregnated with the plasticized material and is discharged from the second opening 193. The ultrasonic wave applying unit 190 may apply, via the plasticized material, the ultrasonic waves to the fiber material FB impregnated with the plasticized material. The ultrasonic wave applying unit 190 may apply the ultrasonic waves only to the fiber material FB or may apply the ultrasonic waves only to the plasticized material.

As illustrated in FIG. 2, the ultrasonic wave applying unit 190 has a contact surface 195 that comes into contact with the plasticized material discharged toward the stage 20. In the illustrated example, the contact surface 195 is a lower surface of the ultrasonic wave applying unit 190. When the contact surface 195 comes into contact with the plasticized material, the fiber material FB in a bundle shape is pressed and opened as illustrated in FIG. 5. Then, the fiber material FB is fixed to a lower shaping layer. The fiber material FB in a bundle shape is pressed against the contact surface 195 and becomes, for example, a ribbon shape. A width of the ribbon-shaped fiber material FB is, for example, 0.5 mm or more and 2 mm or less. A thickness of the ribbon-shaped fiber material FB is, for example, 0.05 mm or more and 0.3 mm or less, and is preferably 0.1 mm or more and 0.2 mm or less. The ribbon-shaped fiber material FB is impregnated with the plasticized material.

A shape of the contact surface 195 is not particularly limited, and an outer edge of the contact surface 195 may be curved. A shape of the ultrasonic wave applying unit 190 is not particularly limited, and may be, for example, a pot-like shape.

The support portion 196 supports the ultrasonic wave applying unit 190. The support portion 196 includes a support arm 197. As illustrated in FIG. 2, the support arm 197 couples, for example, the ultrasonic wave applying unit 190 and the screw case 122. The ultrasonic wave applying unit 190 is detachable from the support arm 197, for example. Therefore, the ultrasonic wave applying unit 190 is detachable from the discharging unit 10. The support portion 196 includes a drive unit (not illustrated). The drive unit includes, for example, a motor.

As illustrated in FIG. 6, the ultrasonic wave applying unit 190 is movable between a first position P1 overlapping the stage 20 and a second position P2 not overlapping the stage 20 as viewed from the Z-axis direction. In FIG. 6, the ultrasonic wave applying unit 190 and the support arm 197 located at the first position P1 are indicated by solid lines, and the ultrasonic wave applying unit 190 and the support arm 197 located at the second position P2 are indicated by broken lines. The drive unit of the support portion 196 moves the ultrasonic wave applying unit 190 between the first position P1 and the second position P2 by moving the support arm 197. In the illustrated example, the first position P1 and the second position P2 are different positions in the Y-axis direction. When the ultrasonic wave applying unit 190 moves between the first position P1 and the second position P2, the position of the nozzle 170 is not moved. For example, when the ultrasonic wave applying unit 190 is at the second position P2, the nozzle 170 is at the first position P1. The drive unit is controlled by the control unit 40.

A temperature of the ultrasonic wave applying unit 190 is lower than a temperature of the nozzle 170, for example. A thermoplastic resin contained in the shaping material MR is, for example, a crystalline resin. Examples of the crystalline resin include PP, PA, PBT, PPS, PEEK, and POM.

Here, FIG. 7 is a graph illustrating a relationship between a temperature and a complex viscosity of PP that is a crystalline resin and an ABS resin that is an amorphous resin. The complex viscosity was measured using a rheometer. In the three-dimensional shaping apparatus 100, the shaping material is heated by the plasticizing unit 120 to reduce the complex viscosity, and is discharged from the nozzle 170 as the plasticized material. The discharged plasticized material is cooled to increase the complex viscosity. When the plasticized material is discharged from the nozzle 170, the complex viscosity is preferably 100,000 Pa·s or less, and is more preferably 10,000 Pa·s or less. Therefore, it is necessary to increase the temperature of the nozzle 170. On the other hand, since the plasticized material deposited on the stage 20 needs to maintain its shape as a shaped object, the complex viscosity is preferably 1,000,000 Pa·s or more.

As illustrated in FIG. 7, the ABS resin, which is not a crystalline resin, has the same complex viscosity value during temperature rise and temperature drop at the same temperature. On the other hand, PP, which is a crystalline resin, has different complex viscosity values during temperature rise and temperature drop even at the same temperature. PP has a viscosity of 1,000,000 Pa·s at a temperature T1 during temperature rise, but does not have a viscosity of 1,000,000 Pa·s unless the temperature is decreased to a temperature T2 lower than the temperature T1 during temperature drop. Therefore, it is necessary to lower the temperature of the shaping layers deposited on the stage to the temperature T2 or lower. When a high-temperature shaping layer is newly laminated on the shaping layer having a low temperature equal to or lower than the temperature T2 as described above, strength at boundaries of both shaping layers decreases since a temperature difference between both shaping layers is large. When the temperature of the lower shaping layer is increased in order to reduce the temperature difference between both shaping layers, the shape of the shaping layer is distorted. Further, the fiber material may be deteriorated.

With respect to the above problem, in the three-dimensional shaping apparatus 100, boundaries of adjacent shaping layers can be fused by the ultrasonic waves of the ultrasonic wave applying unit 190. Therefore, even when the temperature of the ultrasonic wave applying unit 190 is lower than the temperature of the nozzle 170, the strength at the boundaries of the adjacent shaping layers can be improved. Even if the thermoplastic resin is not a crystalline resin, the viscosity of the thermoplastic resin can be reduced by the ultrasonic waves of the ultrasonic wave applying unit 190. Therefore, the ultrasonic waves of the ultrasonic wave applying unit 190 are also effective for an amorphous thermoplastic resin that is not a crystalline resin.

### 1.3. Operations

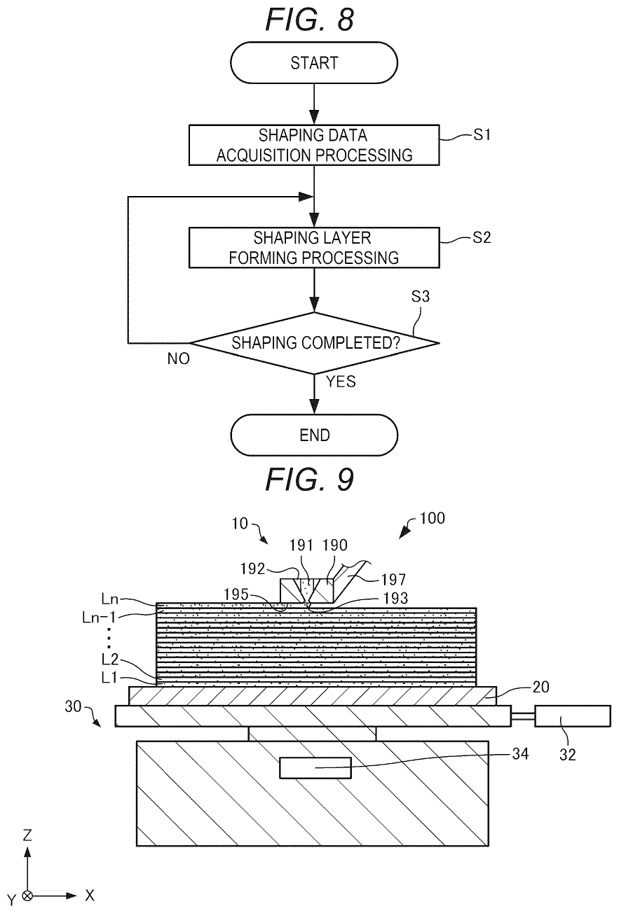

FIG. 8 is a flowchart illustrating operations of the three-dimensional shaping apparatus 100. Specifically, FIG. 8 is a flowchart illustrating processing of the control unit 40.

For example, a user operates an operation unit (not illustrated) to output, to the control unit 40, a processing start signal for starting processing. The operation unit includes, for example, a mouse, a keyboard, or a touch panel. When receiving the processing start signal, the control unit 40 starts the processing.

First, as illustrated in FIG. 8, in step S1, the control unit 40 performs shaping data acquisition processing of acquiring shaping data for shaping a three-dimensional shaped object.

The shaping data includes, for example, information on a type of the shaping material MR supplied from the shaping material supply unit 110, a type of the fiber material FB supplied from the fiber material supply unit 180, a movement path of the discharging unit 10 with respect to the stage 20, the amount of the plasticized material discharged from the discharging unit 10, and the like.

The shaping data is created by, for example, causing slicer software installed in a computer connected to the three-dimensional shaping apparatus 100 to read shape data. The shape data is data representing a target shape of a shaped object created using three-dimensional computer aided design (CAD) software, three-dimensional computer graphics (CG) software, or the like. As the shape data, for example, data in a standard triangulated language (STL) format or an additive manufacturing file format (AMF) is used. The slicer software divides the target shape of the shaped object into layers each having a predetermined thickness and creates shaping data for each of the layers. The shaping data is represented by a G code, an M code, or the like. The control unit 40 acquires shaping data from a computer connected to the three-dimensional shaping apparatus 100 or a recording medium such as a universal serial bus (USB) memory.

Next, as step S2, the control unit 40 performs shaping layer forming processing of forming a shaping layer by discharging the plasticized material and the fiber material FB to the stage 20.

Specifically, the control unit 40 plasticizes the shaping material supplied to between the flat screw 130 and the barrel 140 to generate the plasticized material, and discharges the plasticized material from the nozzle 170. Further, the control unit 40 drives the drive unit of the fiber material supply unit 180. Accordingly, the plasticized material and the fiber material FB are supplied to the ultrasonic wave applying unit 190, and the ultrasonic wave applying unit 190 discharges the plasticized material and the fiber material FB from the second opening 193. The control unit 40 continues to generate the plasticized material until the shaping layer forming processing is completed.

Here, FIG. 9 is a cross-sectional view illustrating the shaping layer forming processing of the three-dimensional shaping apparatus 100. For convenience, the fiber material FB is not illustrated in FIG. 9. In FIG. 9, members of the discharging unit 10 other than the ultrasonic wave applying unit 190 and the support arm 197 are not illustrated.

As illustrated in FIG. 9, based on the acquired shaping data, while controlling the position changing unit 30 to change the relative positions of the discharging unit 10 and the stage 20, the control unit 40 controls the discharging unit 10 to discharge the plasticized material and the fiber material FB from the ultrasonic wave applying unit 190 toward the stage 20.

Specifically, before the shaping layer forming processing is started, that is, before formation of a shaping layer L1 as a first shaping layer is started, the ultrasonic wave applying unit 190 is disposed at an initial position in the −X-axis direction of an end portion of the stage 20 in the −X-axis direction. When the shaping layer forming processing is started, as illustrated in FIG. 9, the control unit 40 controls the position changing unit 30 to, for example, move the ultrasonic wave applying unit 190 in the +X-axis direction relative to the stage 20. When the ultrasonic wave applying unit 190 passes over the stage 20, the plasticized material and the fiber material FB are discharged from the ultrasonic wave applying unit 190. Accordingly, the shaping layer L1 is formed. In FIG. 9, shaping layers up to an n-th shaping layer Ln are shown, with n being any natural number. The Z-axis direction is a lamination direction of shaping layers constituting the shaped object. As illustrated in FIG. 9, the contact surface 195 of the ultrasonic wave applying unit 190 is in contact with the shaping layer deposited on the stage 20. A thickness of the shaping layer Ln is determined by a distance between the contact surface 195 and a shaping layer Ln−1. The distance between the contact surface 195 and the shaping layer Ln−1 is, for example, 0.1 mm or more and 0.2 mm or less.

In the shaping layer forming processing, before the plasticized material for forming the shaping layer Ln is discharged from the ultrasonic wave applying unit 190, the fiber material FB may protrude from the ultrasonic wave applying unit 190 and come into contact with the shaping layer Ln−1. In this state, when the ultrasonic waves are generated by the ultrasonic wave applying unit 190 and the ultrasonic wave applying unit 190 is moved relative to the stage 20, the fiber material FB is pulled in the movement direction of the ultrasonic wave applying unit 190 in a state where a tip end of the fiber material FB is fixed to the shaping layer Ln−1. Therefore, the fiber material FB is fixed to the shaping layer Ln−1 according to a trajectory of the ultrasonic wave applying unit 190. By the ultrasonic waves, the fiber material FB is impregnated with the plasticized material discharged from the ultrasonic wave applying unit 190, and the shaping layer Ln is formed.

In the shaping layer forming processing, the control unit 40 may control the drive unit of the support portion 196 to move the ultrasonic wave applying unit 190 to the second position P2 based on the shaping data. In this case, the fiber material FB is not supplied onto the stage 20. For example, the nozzle 170 is located at the first position P1, and the plasticized material is discharged from the nozzle 170 toward the stage 20 without passing through the ultrasonic wave applying unit 190. The control unit 40 may move the ultrasonic wave applying unit 190 to the first position P1 and discharge the plasticized material and the fiber material FB onto the stage 20 when forming a portion of the shaped object for which the strength is desired to be increased based on the shaping data. The portion of the shaped object for which the strength is desired to be increased may be set by performing stress analysis in advance. Alternatively, the control unit 40 may continue discharging the fiber material FB from the ultrasonic wave applying unit 190 until the shaping layer forming processing is completed.

Next, as illustrated in FIG. 8, in step S3, the control unit 40 performs determination processing of determining whether the formation of all the shaping layers is completed based on the shaping data.

When it is determined that the formation of all the shaping layers is not completed (“NO” in step S3), the control unit 40 returns the processing to step S2. The control unit 40 repeats steps S2 and S3 until it is determined in step S3 that the formation of all the shaping layers is completed.

On the other hand, when it is determined that the formation of all the shaping layers is completed (“YES” in step S3), the control unit 40 ends the processing.

### 1.4. Action Effects

The three-dimensional shaping apparatus 100 includes the plasticizing unit 120 configured to plasticize at least a part of a shaping material containing a thermoplastic resin to generate a plasticized material, the fiber material supply unit 180 configured to supply the fiber material FB, the nozzle 170 configured to discharge the plasticized material, and the ultrasonic wave applying unit 190 including the storage portion 191 for storing the discharged plasticized material and the supplied fiber material FB, and configured to apply ultrasonic waves to at least one of the stored plasticized material and fiber material FB and discharge the plasticized material and fiber material FB toward the stage 20.

Therefore, in the three-dimensional shaping apparatus 100, strength of a shaped object can be improved. Specifically, in the three-dimensional shaping apparatus 100, the fiber material FB can be uniformly impregnated with the thermoplastic resin by the ultrasonic wave applying unit 190, and the strength of the shaped object can be improved. Further, a shaping layer can be laminated while being fused with a lower shaping layer by the ultrasonic wave applying unit 190, and strength at boundaries of adjacent shaping layers can be improved. Further, voids generated in the thermoplastic resin can be reduced by the ultrasonic wave applying unit 190, and the strength of the shaped object can be improved.

In the three-dimensional shaping apparatus 100, the nozzle 170 and the ultrasonic wave applying unit 190 are separated from each other. Therefore, in the three-dimensional shaping apparatus 100, it is possible to prevent the vibration for generating the ultrasonic waves by the ultrasonic wave applying unit 190 from being reduced by the nozzle 170.

In the three-dimensional shaping apparatus 100, the storage portion 191 includes the first opening 192 to which the plasticized material and the fiber material FB are supplied, and the second opening 193 through which the plasticized material and the fiber material FB supplied from the first opening 192 are discharged. Therefore, in the three-dimensional shaping apparatus 100, the plasticized material and the fiber material FB can be discharged from the second opening 193 toward the stage 20.

In the three-dimensional shaping apparatus 100, the area of the first opening 192 is larger than the area of the second opening 193. Therefore, in the three-dimensional shaping apparatus 100, the fiber material FB can be impregnated with the plasticized material with a simple configuration.

In the three-dimensional shaping apparatus 100, the edge 193a of the second opening 193 is curved. Therefore, in the three-dimensional shaping apparatus 100, durability of the fiber material FB can be improved.

The three-dimensional shaping apparatus 100 includes the discharging unit 10 including the plasticizing unit 120 and the nozzle 170. The discharging unit 10 is movable relative to the stage 20, and the ultrasonic wave applying unit 190 is detachable from the discharging unit 10. Therefore, in the three-dimensional shaping apparatus 100, the ultrasonic wave applying unit 190 can be added later.

In the three-dimensional shaping apparatus 100, the ultrasonic wave applying unit 190 is movable between the first position P1 overlapping the stage 20 and the second position P2 not overlapping the stage 20 as viewed from the Z-axis direction. Therefore, in the three-dimensional shaping apparatus 100, when ultrasonic waves are not applied to the plasticized material, the plasticized material can be discharged from the nozzle 170 toward the stage 20 without passing through the ultrasonic wave applying unit 190. Accordingly, the plasticized material can be discharged at a high pressure.

### 2. Modifications of Three-Dimensional Shaping Apparatus

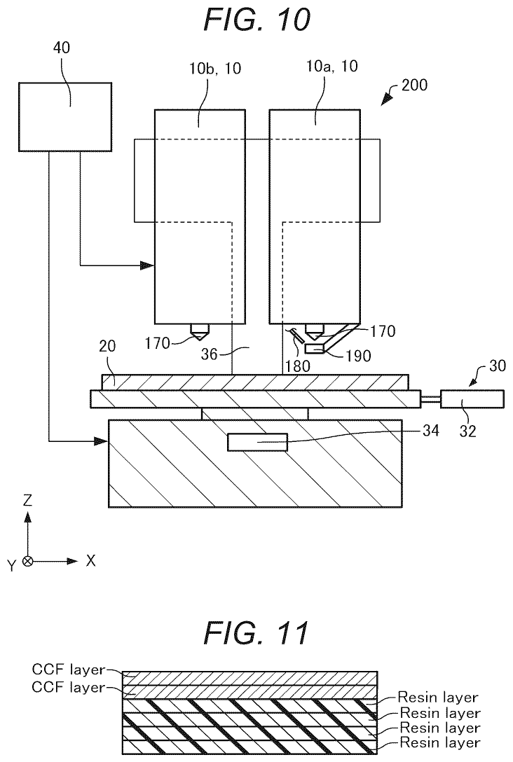

Next, a three-dimensional shaping apparatus according to a modification of the embodiment will be described with reference to the drawings. FIG. 10 is a diagram illustrating a three-dimensional shaping apparatus 200 according to a first modification of the embodiment. For convenience, in FIG. 10, the discharging unit 10 is illustrated in a simplified manner.

Hereinafter, in the three-dimensional shaping apparatus 200 according to the modification of the embodiment, points different from the example of the three-dimensional shaping apparatus 100 according to the embodiment described above will be described, and a description of the same points will be simplified or omitted.

As illustrated in FIG. 1, the three-dimensional shaping apparatus 100 described above includes only one discharging unit 10.

In contrast, as illustrated in FIG. 10, the three-dimensional shaping apparatus 200 includes a plurality of discharging units 10. In the illustrated example, two discharging units 10 are provided. Of the two discharging units 10, one discharging unit 10 is a first discharging unit 10a, and the other discharging unit 10 is a second discharging unit 10b. In the illustrated example, the first discharging unit 10a and the second discharging unit 10b are arranged side by side in the X-axis direction. The fiber material supply unit 180 and the ultrasonic wave applying unit 190 are provided in the first discharging unit 10a and are not provided in the second discharging unit 10b. The first discharging unit 10a includes the fiber material supply unit 180 and the ultrasonic wave applying unit 190. The second discharging unit 10b does not include the fiber material supply unit 180 and the ultrasonic wave applying unit 190.

Based on shaping data, the control unit 40 causes a plasticized material and the fiber material FB to be discharged from the first discharging unit 10a when shaping a portion of a shaped object for which strength is desired to be increased, and causes the plasticized material to be discharged from the second discharging unit 10b when shaping a portion other than the portion for which the strength is desired to be increased.

In the three-dimensional shaping apparatus 200, the two discharging units 10 each including the plasticizing unit 120 and the nozzle 170 are provided, and the ultrasonic wave applying unit 190 is provided in one of the two discharging units 10 and is not provided in the other. Therefore, in the three-dimensional shaping apparatus 200, when ultrasonic waves are not applied to the plasticized material, the plasticized material can be discharged from the nozzle 170 of the other discharging unit 10 toward the stage 20 without passing through the ultrasonic wave applying unit 190. Accordingly, the plasticized material can be discharged at a high pressure.

### 3. Experimental Example

A shaped object was shaped using a three-dimensional shaping apparatus, and the shaped object was observed by X-ray computed tomography (CT). FIG. 11 is a cross-sectional view schematically illustrating the shaped object. As illustrated in FIG. 11, the shaped object includes four resin layers and two CCF layers. The resin layer is formed by mixing short fibers of carbon fibers with a resin. The CCF layer is formed by impregnating a fiber bundle of carbon fibers with a resin. The resin contained in the resin layer and the CCF layer was polyamide 6 (nylon 6). In Example 1, the shaped object was shaped by applying ultrasonic waves by the ultrasonic wave applying unit. In Comparative Example 1, a shaped object was shaped without applying ultrasonic waves.

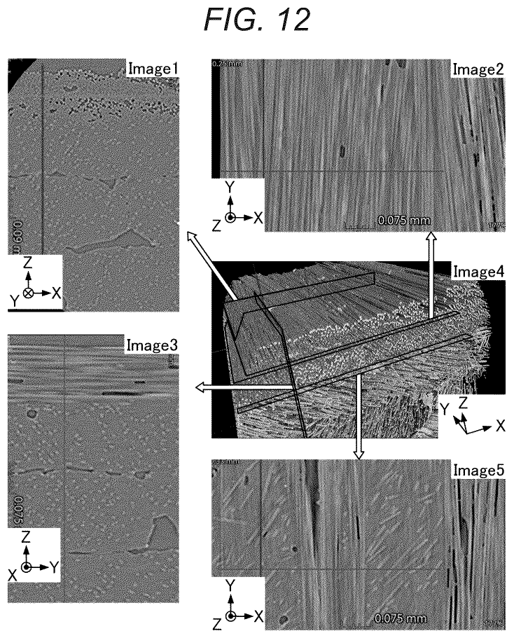

FIG. 12 is an X-ray CT image of the shaped object of Example 1. In FIG. 12, Image4 is a perspective view of the shaped object, and Image1, Image3, and Image5 are cross-sectional views of the shaped object taken along a virtual plane indicated in Image4.

In Image1, the carbon fibers in the CCF layer and the short fibers in the resin layer are represented by a white dot pattern. Image2 is a cross-sectional view of boundaries of the two CCF layers, and the carbon fibers in the CCF layer are represented in a white linear shape. In Image3, the carbon fibers in the CCF layer are represented in a white linear shape, and the short fibers in the resin layer are represented by a white dot pattern. Image5 is a cross-sectional view of boundaries of the CCF layer and the resin layer, the carbon fibers in the CCF layer are represented in a white linear shape, and the short fibers in the resin layer are represented by short white lines extending in an oblique direction.

In FIG. 12, it was found from Image1 and Image3 that the two CCF layers were seamlessly bonded to each other. From Image1, Image3, and Image5, it was found that the layers were mutually diffused at the boundaries of the CCF layer and the resin layer, and the CCF layer and the resin layer were seamlessly bonded to each other. From Image2, it was found that the carbon fibers were uniformly dispersed in the CCF layer and the adjacent carbon fibers were well fused.

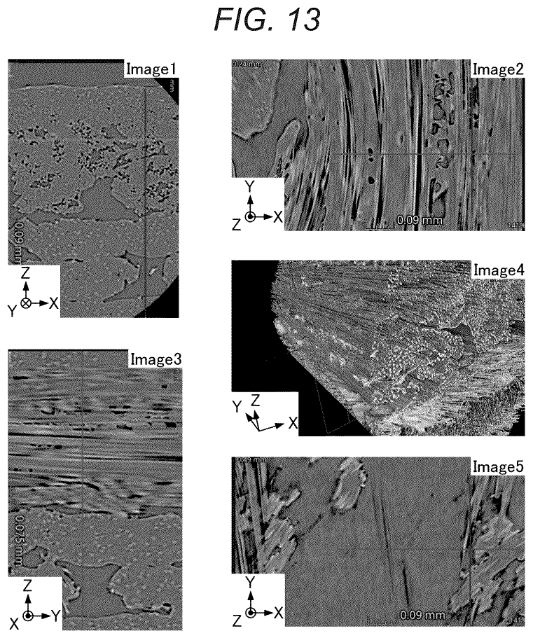

FIG. 13 is an X-ray CT image of the shaped object of Comparative Example 1 to which ultrasonic waves were not applied. Image1 to Image5 in FIG. 13 correspond to Image1 to Image5 in FIG. 12.

In FIG. 13, the density and voids of the carbon fibers were confirmed at boundaries of the two CCF layers from Image1. From Image1, Image3 and Image5, a clear boundary line was confirmed at the boundaries of the CCF layer and the resin layer, and it was found that the layers were not mutually diffused. From Image2, voids were confirmed, and it was found that the carbon fibers were not uniformly dispersed in the CCF layer.

From the X-ray CT image observation described above, it was found that, by applying ultrasonic waves to shape the shaped object, adjacent layers could be mutually diffused and fused at the boundaries of the resin layer and the CCF layer and the boundaries of the CCF layer and the CCF layer. Therefore, it was found that the strength of the shaped object could be improved by ultrasonic waves. Furthermore, it was found that the carbon fibers in the CCF layer could be uniformly opened by applying ultrasonic waves. Furthermore, it was found that voids could be reduced by applying ultrasonic waves.

The embodiment and modifications described above are merely examples, and the present disclosure is not limited thereto. For example, the embodiment and the modifications can be combined with each other as appropriate.

The present disclosure includes a configuration that is substantially the same as the configuration described in the embodiment, such as a configuration having the same function, using the method, and providing the same result, or a configuration having the same object and providing the same advantages. The present disclosure further includes a configuration in which a non-essential portion of the configuration described in the embodiment is replaced with another portion. The present disclosure includes a configuration that has the same action effects as those of the configuration described in the embodiment or a configuration that can achieve the same objects as those achieved by the configuration. The present disclosure includes a configuration obtained by adding a publicly-known technique to the configuration described in the embodiment.

The following contents can be derived from the embodiment and modifications described above.

A three-dimensional shaping apparatus according to an aspect is configured including:
a plasticizing unit configured to plasticize at least a part of a shaping material containing a thermoplastic resin to generate a plasticized material;
a fiber material supply unit configured to supply a fiber material;
a nozzle configured to discharge the plasticized material; and
an ultrasonic wave applying unit including a storage portion for storing the discharged plasticized material and the supplied fiber material, and configured to apply ultrasonic waves to at least one of the stored plasticized material and fiber material and discharge the plasticized material and the fiber material toward a stage.

According to the three-dimensional shaping apparatus, strength of a shaped object can be improved.

The three-dimensional shaping apparatus according to an aspect, in which
the nozzle and the ultrasonic wave applying unit may be separated from each other.

According to the three-dimensional shaping apparatus, it is possible to prevent vibration for generating ultrasonic waves by the ultrasonic wave applying unit from being reduced by the nozzle.

The three-dimensional shaping apparatus according to an aspect, in which
the storage portion may include
   a first opening to which the plasticized material and the fiber material are supplied, and
   a second opening through which the plasticized material and the fiber material supplied from the first opening are discharged.

According to the three-dimensional shaping apparatus, the plasticized material and the fiber material can be discharged from the second opening toward the stage.

The three-dimensional shaping apparatus according to an aspect, in which
an area of the first opening may be larger than an area of the second opening.

According to the three-dimensional shaping apparatus, the fiber material can be impregnated with the plasticized material with a simple configuration.

The three-dimensional shaping apparatus according to an aspect, in which
an edge of the second opening may be curved.

According to the three-dimensional shaping apparatus, durability of the fiber material can be improved.

The three-dimensional shaping apparatus according to an aspect, further including:
a discharging unit including the plasticizing unit and the nozzle, in which
the discharging unit may be movable relative to the stage, and
the ultrasonic wave applying unit may be detachable from the discharging unit.

According to the three-dimensional shaping apparatus, the ultrasonic wave applying unit can be added later.

The three-dimensional shaping apparatus according to an aspect, further including:
two discharging units each including the plasticizing unit and the nozzle, in which
the ultrasonic wave applying unit may be provided in one of the two discharging units and may not be provided in the other.

According to the three-dimensional shaping apparatus, when ultrasonic waves are not applied to the plasticized material, the plasticized material can be discharged from the nozzle toward the stage without passing through the ultrasonic wave applying unit.

The three-dimensional shaping apparatus according to an aspect, in which
the ultrasonic wave applying unit may be movable between a first position overlapping the stage and a second position not overlapping the stage as viewed from a lamination direction of a shaped object.

According to the three-dimensional shaping apparatus, when the ultrasonic waves are not applied to the plasticized material, the plasticized material can be discharged from the nozzle toward the stage without passing through the ultrasonic wave applying unit.

What is claimed is:

1. A three-dimensional shaping apparatus comprising:
a plasticizing unit configured to plasticize at least a part of a shaping material containing a thermoplastic resin to generate a plasticized material;
a fiber material supply unit configured to supply a fiber material;
a nozzle configured to discharge the plasticized material; and
an ultrasonic wave applying unit including a storage portion for storing the discharged plasticized material and the supplied fiber material, and configured to apply ultrasonic waves to at least one of the stored plasticized material and fiber material and discharge the plasticized material and the fiber material toward a stage.

2. The three-dimensional shaping apparatus according to claim 1, wherein
the nozzle and the ultrasonic wave applying unit are separated from each other.

3. The three-dimensional shaping apparatus according to claim 2, wherein
the storage portion includes
a first opening to which the plasticized material and the fiber material are supplied, and
a second opening through which the plasticized material and the fiber material supplied from the first opening are discharged.

4. The three-dimensional shaping apparatus according to claim 3, wherein
an area of the first opening is larger than an area of the second opening.

5. The three-dimensional shaping apparatus according to claim 4, wherein
an edge of the second opening is curved.

6. The three-dimensional shaping apparatus according to claim 2, further comprising:
a discharging unit including the plasticizing unit and the nozzle, wherein
the discharging unit is movable relative to the stage, and
the ultrasonic wave applying unit is detachable from the discharging unit.

7. The three-dimensional shaping apparatus according to claim 1, further comprising:
two discharging units each including the plasticizing unit and the nozzle, wherein
the ultrasonic wave applying unit is provided in one of the two discharging units and is not provided in the other.

8. The three-dimensional shaping apparatus according to claim 1, wherein
the ultrasonic wave applying unit is movable between a first position overlapping the stage and a second position not overlapping the stage as viewed from a lamination direction of a shaped object.
